(19) United States
(12) Patent Application Publication
(10) Pub. No.: US 2026/0111807 A1
(43) Pub. Date: Apr. 23, 2026

(54) CONTAINER MANAGEMENT SYSTEM AND METHOD

(71) Applicant: Swap Out, LLC, Sheridan, WY (US)

(72) Inventor: James McLain, Booth, AL (US)

(73) Assignee: Swap Out, LLC, Sheridan, WY (US)

(21) Appl. No.: 18/918,596

(22) Filed: Oct. 17, 2024

(51) Int. Cl. G06Q 10/0631; G06K 7/14

(52) U.S. Cl. CPC G06Q 10/0631; G06K 7/1417

(57) ABSTRACT

A container management system including a transceiver and a processor is disclosed. The transceiver may receive a request associated with a container and a user device location from a user device. The processor may obtain the request and the user device location from the transceiver, and may estimate a container location based on the user device location. The processor may further predict a type of content stored in the container based on the container location. The processor may additionally transmit an information associated with the type of content and the request to an external computing device.

### FIELD

The present disclosure relates to a container management system and method, and more specifically to a system and method for facilitating efficient pickup and delivery of scrap or trash containers/bins.

### BACKGROUND

Firms operating in the scrap or trash industry manage pickup, delivery and/or replacement of scrap or trash containers/bins. Conventionally, a user requiring a pickup or replacement of a filled trash container has to call a firm operator and then request the operator to arrange for the container pickup or replacement. This conventional process of arranging the container pickup/replacement is tedious and may cause inconvenience to the user in some scenarios (e.g., when the operator is unavailable).

Furthermore, many-a-times, the firm operator may not be able to receive full information for the container pickup from the user, which may result in a suboptimal service experience for the user. For example, if the firm operator is not able to receive the correct address or the preferred pickup timeslot for the container, the operator and the user may face inconvenience.

Therefore, a system and method is required that enables efficient container management.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a first example view of a user device interface in accordance with the present disclosure.

FIG. 3 depicts a second example view of a user device interface in accordance with the present disclosure.

FIG. 4 depicts a flow diagram of an example container management method in accordance with the present disclosure.

### DETAILED DESCRIPTION

### Overview

The present disclosure describes a container management system and method for facilitating efficient pick-up and replacement of trash or scrap containers/bins in a geographical area. The system may be hosted on a server and may communicatively couple with a plurality of devices/units, e.g., a user device associated with a user, a computing device associated with a firm that manages pick-up and replacement of a plurality of containers, and/or the like. In an exemplary aspect, each container may include an identifier (e.g., a Quick-Response (QR) Code) that may be adhered on the container body.

The user may scan the QR code on a container via the user device when the user desires the firm to replace the container (or add another container at the container's current location). Responsive to the user scanning the QR code, the system may receive the user device location and the user's request to replace the container from the user device. The system may estimate the container's current location based on the user device location. The system may further predict a type of content/trash that the container may contain based on the container's current location. For example, the system may predict that the container may contain steel scrap when the container's current location is a steel processing plant. As another example, the system may predict that the container may contain household trash when the container's current location is a residential location.

Responsive to predicting the content type, the system may transmit information associated with the content type and the user's request to the computing device associated with the firm, so that the firm may accordingly service the request. In an exemplary aspect, the firm may use the content type information to dispose the content stored in the container in a secure manner and send an appropriate replacement container to the container location.

In additional aspects, the system may transmit a reminder notification to the user device when the system determines that the container may require a replacement. The system may determine an optimal time to transmit the reminder notification based on historical frequency of container replacements and/or an average size of content/trash that is typically stored in the container.

The present disclosure discloses a container management system and method that facilitates in efficient pick up and replacement of trash/scrap containers. A user may conveniently request for a container replacement by scanning a QR code present on the container. The system further automatically predicts the type of content stored in the container, so that the firm may appropriately dispose the content and send an optimal replacement container to the user. The system additionally transmits reminder notifications to the user, so that the user may request for the container replacement in a timely manner.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

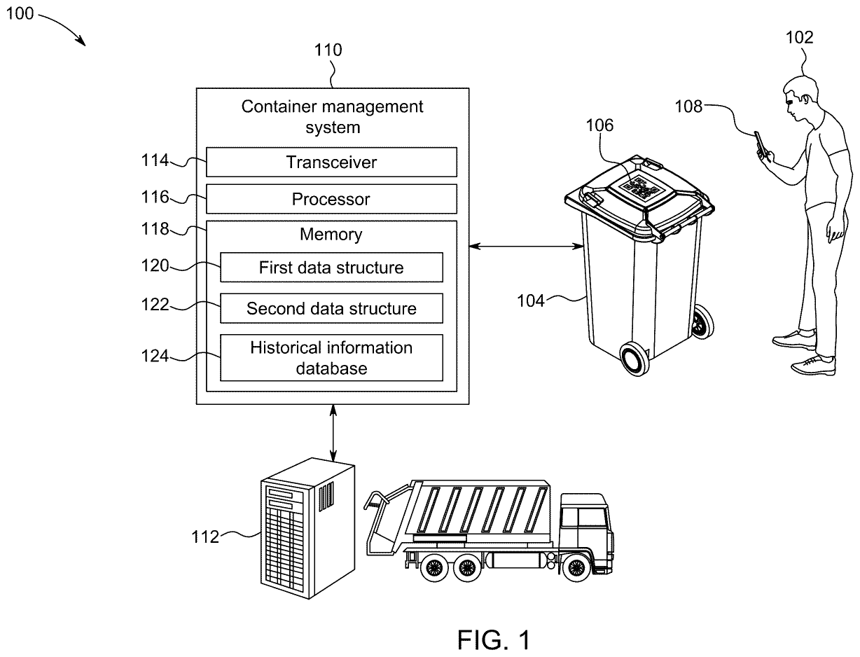

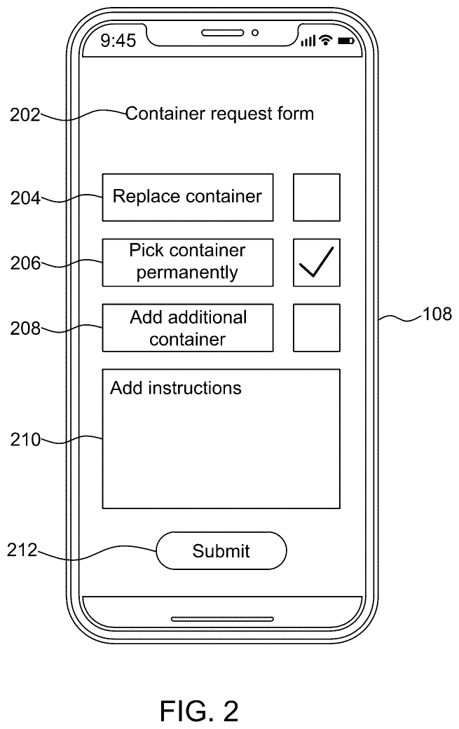

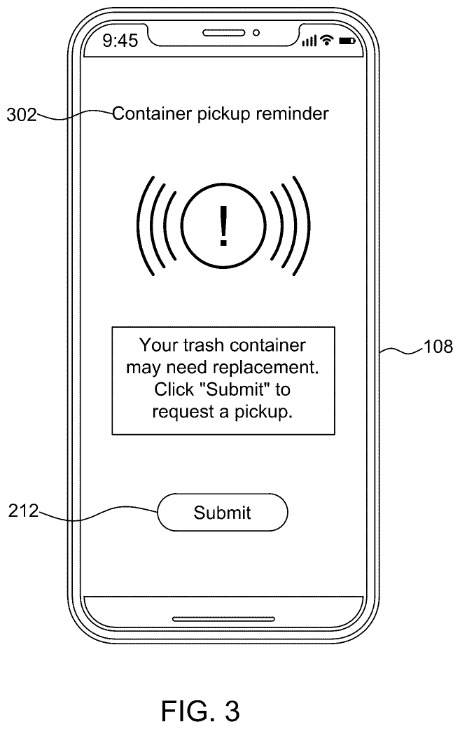

FIG. 1 depicts an environment 100 in which techniques and structures for providing the systems and methods disclosed herein may be implemented. FIG. 1 will be described in conjunction with FIGS. 2 and 3.

The environment 100 may include a user 102 located in proximity to a bin/container 104. The container 104 may be a trash or scrap bin, which may store trash, scrap, garbage, etc. The container 104 may have any size based on an amount of content that the container 104 is expected to store. The container 104 may have a hollow interior portion (not shown) in which the user 102 may store the content (e.g., trash, scrap, etc.) to be disposed of.

In some aspects, the container 104 may include an identifier 106 that may be disposed or located on an exterior surface of one or more container walls. For example, the identifier 106 may be pasted/adhered to the exterior surface of one of a container sidewall or a top lid/cover, as shown in FIG. 1. The identifier 106 may be, for example, a Quick-Response (QR) Code, a Radio Frequency Identification (RFID) tag, or any other similar code/tag that may be adhered to the container 104. The identifier 106 may be associated with the container 104 and/or a firm that manages the pickup or replacement of the container 104 (and a plurality of other containers, not shown in FIG. 1).

The environment 100 may further include a user device 108 through which the user 102 may scan the identifier 106. The user device 108 may be, for example, a mobile phone, a laptop, a tablet, a smartwatch, or any other similar device with communication and identifier scanning capabilities.

The environment 100 may further include a container management system 110 (or system 110) that facilities efficient management of pickup, drop, replacement, etc. of a plurality of containers (including the container 104) in a geographical area (e.g., city, state, etc.). A server may host the system 110, and the system 110 may communicatively couple with a plurality of systems/devices including the user device 108, an external computing device or server 112, and/or the like, via one or more networks. The network(s), as described here, illustrates an example communication infrastructure in which the connected devices discussed in various embodiments of this disclosure may communicate. The network(s) may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The server 112 may be associated with a firm that manages the pickup, drop, replacement, etc. of the plurality of containers (including the container 104) in the geographical area. In an exemplary aspect, the firm picks-up filled containers from the geographical area and replaces them with empty containers. The firm may further efficiently dispose the content included in the filled containers in a secure and environment-friendly manner. For example, the firm may arrange pickup of a trash container containing household trash from a residential area, and may dispose the household trash in a recycling facility. As another example, the firm may arrange pickup of a scrap container including steel scrap from a steel processing plant, and may dispose the steel scrap in a scrapyard. In an exemplary aspect, the firm may own the plurality of containers (including the container 104) in the geographical area.

The system 110 may include a plurality of units/components including, but not limited to, a transceiver 114, a processor 116 and a memory 118. The transceiver 114 may receive data/information/signals from the system 110 components and/or external systems, e.g., the user device 108, the server 112, etc. Further, the transceiver 114 may transmit data/information/signals to the system 110 components and/or the external systems. For example, the transceiver 114 may transmit command signals or notifications to the user device 108, or data/information to the server 112.

The processor 116 may utilize the memory 118 to store programs in code and/or to store data for performing aspects in accordance with the disclosure. The memory 118 may be a non-transitory computer-readable storage medium or memory storing a program code that enables the processor 116 to perform operations in accordance with the present disclosure. The memory 118 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 118 may include/store a first data structure 120, a second data structure 122 and a historical information database 124. The first data structure 120 may include a mapping of a plurality of locations in the geographical area with a plurality of location types. For example, if the geographical area includes locations A, B, C . . . N, the first data structure 120 may include a mapping of each of these locations with their respective location type. For example, the first data structure 120 may include the mapping that indicates that the location A is a residential location, the location B is an office building, the location C is steel processing plant, the location N is a park, and/or the like. In this case, “residential location”, “office building”, “steel processing plant”, “park”, etc. are examples of location types.

The second data structure 122 may include a mapping of the plurality of location types (described above) with a plurality of types of trash or scrap content (“content”) that may be present or generated at each location type. For example, if the location type is “residential location”, the second data structure 122 may include the mapping that indicates that the residential location may generate household trash (as content type). As another example, if the location type is “steel processing plant”, the second data structure 122 may include the mapping that indicates that the steel processing plant may generate scrap steel (as content type).

The historical information database 124 may include/store historical information associated with each container (of the plurality of containers) located at different locations in the geographical area. For example, the historical information database 124 may store historical information associated with the container 104 when the container 104 may be located at the locations A, B, C . . . and/or N. In some aspects, the historical information may include an information associated with a frequency of past container pickups or replacements at each of the locations A, B, C . . . and/or N. For example, the historical information may indicate that the container 104 was picked up every 4 days (on average over a predefined past time duration, e.g., over the past 3-6 months) when the container 104 was located at the location A, every 6 days (on average) when the container 104 was located at the location B, every 2 days (on average) when the container 104 was located at the location C, and/or the like.

In additional aspects, the historical information may include an information associated with an average size of content historically stored in each container at different locations in the geographical area. For example, the historical information may indicate that large-sized items/trash (e.g., electronics goods/trash) was stored in the container 104 when the container 104 was located at the location C, small-sized trash (e.g., household trash) was stored in the container 104 when the container 104 was located at the location A, and/or the like.

In operation, the user 102 may scan the identifier 106 on the container 104 via the user device 108 (e.g., via a system application or “app” installed on the user device 108) when the user 102 desires the firm described above to pick up the container 104 and/or add additional containers at the location where the container 104 is placed. Responsive to the user device 108 scanning the identifier 106, the user device 108 may transmit a trigger signal to the transceiver 114. Stated another way, the transceiver 114 may receive the trigger signal from the user device 108 when the user device 108 scans the identifier 106.

In some aspects, in addition to transmitting the trigger signal, the user device 108 may transmit a real-time Global Positioning System (GPS) information associated with the user device 108 (or “user device location”) to the transceiver 114, when the user device 108 scans the identifier 106. In this manner, the transceiver 114 may automatically receive the user device location from the user device 108 based on the real-time user device GPS information.

The processor 116 may obtain the trigger signal and the user device location from the transceiver 114. Responsive to obtaining the trigger signal, the processor 116 may transmit, via the transceiver 114, a command signal to the user device 108 to cause the user device 108 to render a request input page/form 202 on a user device display screen/user interface, as shown in FIG. 2. In some aspects, the form 202 may enable/facilitate the user 102 to input a user's request (“request”) associated with the container 104 on the user device 108.

In an exemplary aspect, the request may include, a request to replace the container 304 at the container's current location (shown as a request 204 in FIG. 2), a request to remove the container 304 permanently from the container's current location (shown as a request 206 in FIG. 2), or a request to add an additional container at the container 104 current location (shown as a request 208 in FIG. 2). The example types of requests depicted in FIG. 2 should not be construed as limiting, and the form 202 may include more or less types of requests without departing from the present disclosure scope.

In further aspects, the form 202 may include a section 210 in which the user 102 may add special or specific instructions (that may be part of the request described above) associated with the container 104 pickup or replacement. For example, the user 102 may add contact details of the person to contact when the firm operator arrives to pick up the container 104 at the container location, a preferred timeslot for the container pickup, and/or the like. In an exemplary aspect, the special instructions may also include information associated with a type of content (e.g., oil, hazardous material, etc.) that is stored in the container 104 and the user's instructions to safely dispose the content (i.e., instructions for disposal of content stored in the container 104). In yet another aspect, the special instructions may include information associated with the container's current location or the user device's current location. When the user 102 adds the container or user device's current location in the special instructions, the transceiver 114 may receive the user device location based on the user inputs included in the special instructions (and may not necessarily require the user device's GPS information to receive the user device location).

Responsive to the user device 108 rendering the form 202 on the user device display screen, the user 102 may add the details described above (i.e., the request type from the requests 204, 206, 208), the special instructions, etc. on the form 202 and may then submit the request via a submit button 212 on the form 202. The user device 108 may transmit the request details (or the “request”) to the transceiver 114, responsive to the user 102 submitting the request.

The transceiver 114 may receive the request from the user device 108 and may transmit the request to the processor 116. In this manner, the processor 116 obtains the request via the transceiver 114 and the form 202. Responsive to obtaining the request, the processor 116 may transmit, via the transceiver 114, a confirmation notification to the user device 108 indicating to the user 102 that the system 110/processor 116 has successfully received the request. The processor 116 may further estimate the container's current location based on the user device location that the processor 116 obtains from the user device 108 via the transceiver 114. In some aspects, since the processor 116 obtains the user device location from the user device 108 when the user 102 scans the identifier 106 that is pasted on the container 104, the processor 116 may estimate/determine the container's current location to be substantially equivalent to (or the same as) the user device location.

Responsive to estimating the container's current location, the processor 116 may fetch the first data structure 120 from the memory 118 and correlate the container's current location with the first data structure 120 to determine a container location type. For example, if the container's current location is the location “C” (which may be, for example, a steel processing plant), the processor 116 may correlate the location “C” with the first data structure 120 to determine that the container location type is the steel processing plant. Stated another way, in this case, the processor 116 may correlate the location “C” with the first data structure 120 to determine that the container 104 is located at a steel processing plant. As another example, if the container's current location is the location “A” (which may be, for example, a residential location), the processor 116 may correlate the location “A” with the first data structure 120 to determine that the container location type is the residential location. Stated another way, in this case, the processor 116 may correlate the location “A” with the first data structure 120 to determine that the container 104 is located at a residential location.

Responsive to determining the container location type as described above, the processor 116 may correlate the container location type with the second data structure 122 to predict the type of content that may be stored in the container 104. For example, if the container location type is the steel processing plant, the processor 116 may correlate “steel processing plant” with the second data structure 122 to determine that steel scrap (as the content type) may be stored/present in the container 104. As another example, if the container location type is the residential location, the processor 116 may correlate “residential location” with the second data structure 122 to determine that household trash (as the content type) may be stored/present in the container 104.

In this manner, the processor 116 predicts the type of content (“content type”) that the container 104 may store based on the estimated container's current location (by using the first and second data structures 120, 122). Responsive to predicting the content type, the processor 116 may transmit, via the transceiver 114, information associated with the content type and the request details (e.g., the request type from the requests 204, 206, 208, the special instructions, etc., as described above) to the server 112 (and hence to the firm responsible for the container 104 management).

A person ordinarily skilled in the art may appreciate that the information associated with the content type and the request details may enable the firm to efficiently service the user's request and appropriately dispose the content present in the container 104. For example, if the content type is steel scrap, the firm may instruct the firm operator responsible for picking the container 104 to dispose the content in a scrapyard. The firm may further compensate the user 102 in return of monetary benefits that the firm/user 102 may obtain from the scrapyard for the steel scrap. As another example, if the content type is household trash, the firm may instruct the firm operator responsible for picking the container 104 to dispose the content in a recycling plant/facility. Such content type information may additionally assist the firm to send an appropriate container as replacement for the container 104. For example, the firm may send a container suitable for steel scrap as replacement for the container 104 when the content type is steel scrap, and may send a container suitable for household trash as replacement when the content type is household trash.

The information associated with the content type may further assist the firm to send an appropriate vehicle to pick up the container 104, based on the content type. In a similar manner, the request details may assist the firm to send the vehicle for the container pickup at the timeslot desired by the user 102.

In further aspects, the processor 116 may perform one or more additional actions to efficiently manage container pickup/replacement. For example, in some aspects, when the container 104 is located at a specific location (e.g., at the location A), the processor 116 may predict an estimated future time when the container 104 is expected to require a replacement based on the historical information associated with the container 104 located at the location A. In one exemplary aspect, the processor 116 may predict the estimated future time for container 104 pickup/replacement based on the historical information associated with the frequency of past container 104 pickups/replacements at the location A. For example, if the historical information associated with the frequency indicates that the container 104 is usually picked up and replaced every 4 days from the location A, the processor 116 may predict the estimated future time for the container 104 pickup/replacement as 4 days after the firm places the container 104 at the location A.

In another exemplary aspect, the processor 116 may predict the estimated future time for container 104 pickup/replacement based on the historical information associated with the size of content historically stored in the container 104 at the location A. For example, if the historical information associated with the size of content indicates that the container 104 is usually filled with large-sized items at the location A, the processor 116 may predict that the container 104 may fill quickly and hence may require pickup/replacement more frequently. In this case, the processor 116 may predict the estimated future time for container 104 pickup/replacement to be 1 or 2 days after the firm places the container 104 at the location A. As another example, if the historical information associated with the size of content indicates that the container 104 is usually filled with small-sized items at the location A, the processor 116 may predict that the container 104 may fill less quickly and hence may require pickup/replacement less frequently. In this case, the processor 116 may predict the estimated future time for container 104 pickup/replacement to be 3 or 4 days (or more) after the firm places the container 104 at the location A.

Responsive to predicting the estimated future time for the container 104 pickup/replacement, the processor 116 may transmit, via the transceiver 114, a reminder notification 302 (as shown in FIG. 3) to the user device 108 at the estimated future time. The reminder notification 302 may facilitate the user 102 to request for the container 104 pickup/replacement in a timely manner, without forgetting or delaying the replacement. FIG. 3 depicts an example reminder notification 302 that states, “Your trash container may need replacement. Click “Submit” to request a pickup.” In this case, the user 102 may follow the instructions included in the reminder notification 302 to transmit the request described above to the transceiver 114/processor 116, to conveniently enable the container 104 pickup/replacement. The example reminder notification 302 depicted in FIG. 3 should not be construed as limiting, and the reminder notification 302 may include more or less details than the details shown in FIG. 3 without departing from the present disclosure scope.

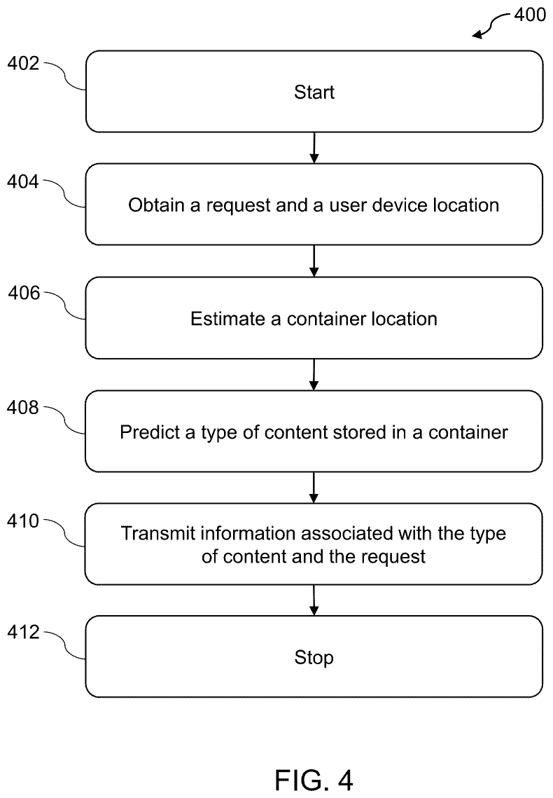

FIG. 4 depicts a flow diagram of an example container management method 400 in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include obtaining, by the processor 116, the request associated with the container 104 and the user device location from the user device 108. At step 406, the method 400 may include estimating, by the processor 116, the container's current location based on the user device location. At step 408, the method 400 may include predicting, by the processor 116, the type of content stored in the container 104 based on the container location. At step 410, the method 400 may include transmitting, by the processor 116, an information associated with the type of content and the request to the server 112.

At step 412, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A container management system comprising:
a transceiver configured to receive a request associated with a container and a user device location from a user device; and
a processor configured to:
estimate a container location based on the user device location;
predict a type of content stored in the container based on the container location; and
transmit an information associated with the type of content and the request to an external computing device.

2. The container management system of claim 1, wherein the container comprises an identifier, and wherein the transceiver receives the user device location when the user device scans the identifier on the container.

3. The container management system of claim 2, wherein the identifier comprises a Quick-Response (QR) code.

4. The container management system of claim 2, wherein the processor is further configured to:
obtain a trigger signal when the user device scans the identifier on the container;
transmit a command signal to the user device to render a request input page on a user device display screen, responsive to obtaining the trigger signal; and
obtain the request from the user device via the request input page.

5. The container management system of claim 1, wherein the request comprises at least one of: a request to replace the container, a request to remove the container permanently from the container location, or a request to add an additional container at the container location.

6. The container management system of claim 5, wherein the request further comprises user's special instructions for pickup or disposal of content stored in the container.

7. The container management system of claim 1 further comprising a memory configured to store:
a first data structure comprising a mapping of a plurality of locations with a plurality of location types, and
a second data structure comprising a mapping of the plurality of location types with a plurality of types of content.

8. The container management system of claim 7, wherein the processor is further configured to:
correlate the container location with the first data structure to determine a container location type; and
correlate the container location type with the second data structure to predict the type of content stored in the container.

9. The container management system of claim 1, wherein the processor is further configured to:
predict an estimated future time when the container is expected to require a replacement based on historical information associated with the container located at the container location; and
transmit a reminder notification to the user device at the estimated future time.

10. The container management system of claim 9, wherein the historical information comprises an information associated with a frequency of past container pickups or replacements at the container location.

11. The container management system of claim 9, wherein the historical information comprises an information associated with a size of content historically stored in the container at the container location.

12. The container management system of claim 1, wherein the transceiver receives the user device location based on user inputs.

13. The container management system of claim 1, wherein the transceiver receives the user device location based on a real-time Global Positioning System (GPS) information associated with the user device.

14. A container management method comprising:
obtaining, by a processor, a request associated with a container and a user device location from a user device;
estimating, by the processor, a container location based on the user device location;
predicting, by the processor, a type of content stored in the container based on the container location; and
transmitting, by the processor, an information associated with the type of content and the request to an external computing device.

15. The container management method of claim 14, wherein the container comprises an identifier, and wherein the user device location is obtained when the user device scans the identifier on the container.

16. The container management method of claim 15 further comprising:
obtaining a trigger signal when the user device scans the identifier on the container;
transmitting a command signal to the user device to render a request input page on a user device display screen, responsive to obtaining the trigger signal; and
obtaining the request from the user device via the request input page.

17. The container management method of claim 14 further comprising:
correlating the container location with a first data structure to determine a container location type, wherein the first data structure comprises a mapping of a plurality of locations with a plurality of location types; and
correlating the container location type with a second data structure to predict the type of content stored in the container, wherein the second data structure comprises a mapping of the plurality of location types with a plurality of types of content.

18. The container management method of claim 14 further comprising:
predicting an estimated future time when the container is expected to require a replacement based on historical information associated with the container located at the container location; and
transmitting a reminder notification to the user device at the estimated future time.

19. The container management method of claim 18, wherein the historical information comprises an information associated with a size of content historically stored in the container at the container location.

20. A non-transitory computer-readable storage medium having instructions stored thereupon which, when executed by a processor, cause the processor to:
obtain a request associated with a container and a user device location from a user device;
estimate a container location based on the user device location;
predict a type of content stored in the container based on the container location; and
transmit an information associated with the type of content and the request to an external computing device.
